(19) United States
(12) Patent Application Publication
(10) Pub. No.: US 2025/0357661 A1
(43) Pub. Date: Nov. 20, 2025

(54) WEARABLE ELECTRONIC DEVICE COMPRISING ANTENNA

(71) Applicant: Samsung Electronics Co., Ltd., Suwon-si, Gyeonggi-do (KR)

(72) Inventors: Yongjoo SHIN, Suwon-si, Gyeonggi-do (KR); Sohyeon KIM, Suwon-si, Gyeonggi-do (KR); Inyoung LEE, Suwon-si, Gyeonggi-do (KR); Donguk CHOI, Suwon-si, Gyeonggi-do (KR)

(21) Appl. No.: 18/730,698

(22) PCT Filed: Jan. 17, 2023
(86) PCT No.: PCT/KR2023/000793

§ 371 Date: Jun. 9, 2025

(30) Foreign Application Priority Data
Jan. 21, 2022 (KR) 10-2022-0009201
May 20, 2022 (KR) 10-2022-0062198

(51) Int. Cl. H01Q 1/27; H01Q 1/48

(52) U.S. Cl. CPC H01Q 1/273; H01Q 1/48

(57) ABSTRACT

Disclosed is a wearable electronic device comprising an antenna. A wearable electronic device according to an embodiment may comprise: a housing comprising a front surface facing in a first direction, a rear surface facing in a second direction opposite to the first direction, and a lateral surface surrounding an inner space between the front and rear surfaces; a printed circuit board which is disposed in the inner space and comprises a ground; an antenna structure for transmitting/receiving radio signals; and a processor. The antenna structure may comprise: a wireless communication circuit disposed on the printed circuit board; a lateral frame made of a conductive material, the lateral frame forming at least a part of the lateral surface while surrounding the periphery of the printed circuit board, and the lateral frame comprising a pair of rung portions to which a strap is connected, a first connecting portion for connecting the pair of rung portions, and a second connecting portion for connecting the pair of rung portions while being opposite the first connecting portion; a feeding portion for applying an electric signal to the lateral frame; and a switching circuit comprising one or more ground portions for selectively connecting the printed circuit board and the lateral frame. The processor may operate the switching circuit such that an electric signal applied to the lateral frame in a first mode moves via the rung portions, and may operate the switching circuit such that an electric signal applied to the lateral frame in a second mode bypasses the rung portions.

### TECHNICAL FIELD

Embodiments set forth in the present disclosure relate to a wearable electronic device including an antenna.

### BACKGROUND ART

With the development of technology, electronic devices capable of wireless communication with external devices have become necessities of life. An electronic device may communicate with a network using an antenna, and transmit and receive signals in various frequency bands depending on the country, telecommunication company, and functions in use.

Recently, wearable electronic devices that are mounted on the bodies (e.g., wrists) of users for use have been developed. Wearable electronic devices are manufactured in lightweight and miniaturized forms to be mounted easily on the bodies. Various technologies are being developed to apply an antenna structure for wireless communication to the limited space of wearable electronic devices.

### DISCLOSURE OF THE INVENTION

### Technical Solutions

To apply an antenna to an electronic device to transmit and receive signals in various frequency bands, an inner space of the electronic device may be required to install the antenna component therein.

Since wearable electronic devices need to be manufactured in compact sizes due to the nature of their use, antenna installation techniques for efficient use of limited inner space are being developed. For example, an inner space of a wearable electronic device may be secured by forming a conductive portion in at least a portion of a housing that forms the exterior of the wearable electronic device and using the conductive portion as a radiator of an antenna.

When a wearable electronic device is mounted on the body of a user, for example, when a watch-type wearable electronic device is mounted on the wrist of a user with a strap, the antenna performance of the wearable electronic device may vary depending on the material of the strap. For example, if the strap includes a metal material, the performance of an antenna included in the wearable electronic device may be reduced.

According to embodiments, stable and constant antenna performance may be secured by changing an electrical path through which an electrical signal flows according to the state of use of a wearable electronic device.

The technical goals to be achieved through embodiments of the present disclosure are not limited to those described above, and other technical goals not mentioned above are clearly understood by one of ordinary skill in the art from the following description.

A wearable electronic device 401 according to an embodiment may include a housing 400 including a front surface 400A, a rear surface 400B facing a direction opposite the front surface 400A, and a side surface 400C surrounding an inner space between the front surface 400A and the rear surface 400B, a PCB 430 disposed in the inner space and including a ground, a wireless communication circuit disposed on the PCB 430, an antenna structure electrically connected to the wireless communication circuit and configured to transmit and receive a wireless signal, and a processor 420, wherein the housing 400 may include a first lug 4001a and a second lug 4001b formed on the side surface 400C so that a first strap 450 may be mounted thereon, and a third lug 4001c and a fourth lug 4001d formed on the side surface 400C so that a second strap 460 may be mounted thereon. The antenna structure may include a side frame 410 of a conductive material surrounding the PCB 430 and forming at least a portion of the side surface 400C, a feeder 470 configured to apply an electrical signal to the side frame 410, and a plurality of ground portions 480 configured to selectively connect the side frame 410 to the ground. The plurality of ground portions 480 may include a first ground portion 481 selectively connected to a first point 4131 of the side frame 410 adjacent to the first lug 4001a, a second ground portion 482 selectively connected to a second point 4132 of the side frame 410 adjacent to the second lug 4001b, a third ground portion 483 selectively connected to a third point 4133 of the side frame 410 adjacent to the third lug 4001c, and a fourth ground portion 484 selectively connected to a fourth point 4143 of the side frame adjacent to the fourth lug 4001d.

An operating method of a wearable electronic device 401 according to an embodiment may include transmitting and receiving an electrical signal in a corresponding frequency band through an electrical path formed in a side frame 410 to which a strap 450 or 460 is connected, detecting a voltage standing wave ratio of the electrical signal based on a set time unit, determining whether to change the electrical path formed in the side frame 410 based on the detected voltage standing wave ratio, changing the electrical path formed in the side frame 410, and transmitting and receiving an electrical signal in a frequency band corresponding to the changed electrical path.

A wearable electronic device according to an embodiment may include a housing 400 including a front surface 400A facing a first direction, a rear surface 400B facing a second direction opposite the first direction, and a side surface 400C surrounding an inner space between the front surface 400A and the rear surface 400B, a PCB 430 disposed in the inner space, a wireless communication circuit disposed on the PCB 430, a processor 420, and an antenna structure configured to transmit and receive a wireless signal. The housing 400 may include a first lug 4001a and a second lug 4001b connected to the side surface 400C so that a first strap 450 may be mounted thereon, and a third lug 4001c and a fourth lug 4001d connected to the side surface 400C so that a second strap 460 may be mounted thereon. The antenna structure may include a side frame 410 of a conductive material surrounding the PCB 430, forming at least a portion of the side surface 400C, and including a first portion 4111 positioned between the first lug 4001a and the second lug 4001b, a second portion 4112 positioned between the second lug 4001b and the third lug 4001c, a third portion 4113 positioned between the third lug 4001c and the fourth lug 4001d, and a fourth portion 4114 positioned between the fourth lug 4001d and the first lug 4001a, a feeder 470 connected to a feed point 474 of the side frame 410 and configured to apply an electrical signal to the side frame, and a plurality of ground portions 480 configured to selectively connect different points of the side frame 410 to a ground so that an electrical path formed in the side frame 410 may change. The wireless communication circuit may be configured to transmit and receive a signal in a first frequency band when a first electrical path that passes through the first portion 4111 or the third portion 4113 is formed in the side frame 410, and transmit and receive a signal in a second frequency band when a second electrical path that bypasses the first portion 4111 and the third portion 4113 is formed in the side frame 410.

### Effects of the Invention

According to an embodiment, it is possible to secure stable antenna performance by changing an electrical path formed in a side frame depending on the material of a strap.

According to an embodiment, in a case where a strap including a conductive material is mounted in a housing, it is possible to prevent a loss of an electrical signal through a strap by blocking the electrical signal from flowing to a lug portion to which the strap is connected.

According to an embodiment, it is possible to perform wireless communication in a frequency band suitable for the state of use of a wearable electronic device by detecting a change in the impedance of an electrical signal.

### BRIEF DESCRIPTION OF DRAWINGS

FIG. 1 is a block diagram of an electronic device in a network environment according to an embodiment.

FIG. 2 is a block diagram of a wireless communication module, a power management module, and an antenna module of an electronic device according to an embodiment.

FIG. 3A is a front perspective view of a wearable electronic device according to an embodiment.

FIG. 3B is a rear perspective view of a wearable electronic device according to an embodiment.

FIG. 3C is an exploded perspective view of a wearable electronic device according to an embodiment.

FIG. 4A is a plan view of a wearable electronic device according to an embodiment.

FIG. 4B is a plan view illustrating an antenna structure of a wearable electronic device according to an embodiment.

FIG. 4C is a block diagram illustrating an antenna structure of a wearable electronic device according to an embodiment.

FIG. 4D is a graph illustrating a signal loss due to metal straps mounted on a wearable electronic device according to an embodiment.

FIGS. 5A to 5D are diagrams illustrating paths through which an electrical signal moves in response to an operation of a switching circuit of a wearable electronic device according to an embodiment.

FIG. 6A is a plan view illustrating an antenna structure of a wearable electronic device according to an embodiment.

FIGS. 6B and 6C are diagrams respectively illustrating paths through which an electrical signal moves in response to an operation of a switching circuit of a wearable electronic device according to an embodiment.

FIG. 7 is a flowchart illustrating an operating method of a wearable electronic device according to an embodiment.

### BEST MODE FOR CARRYING OUT THE INVENTION

Hereinafter, embodiments will be described in detail with reference to the accompanying drawings. When describing the embodiments with reference to the accompanying drawings, like reference numerals refer to like components, and any repeated description related thereto will be omitted.

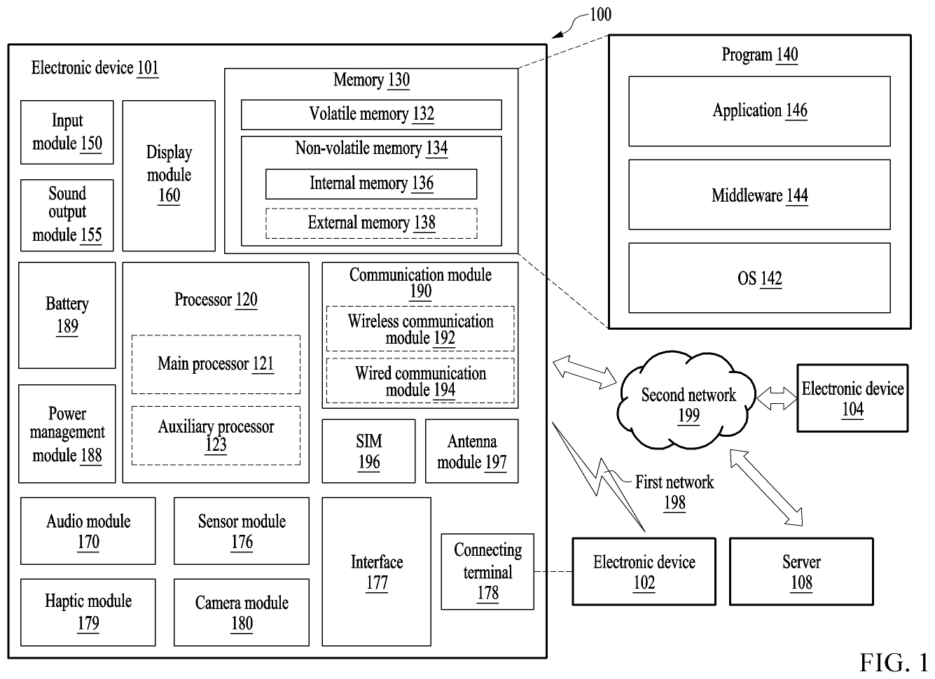

FIG. 1 is a block diagram of an electronic device in a network environment according to various embodiments. Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented as separate from, or as part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An artificial intelligence model may be generated by machine learning. Such learning may be performed, e.g., by the electronic device 101 where the artificial intelligence is performed, or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a record. The receiver may be used for receiving incoming calls. According to an embodiment, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to sense a touch, or a pressure sensor adapted to measure an intensity of a force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that operate independently of the processor 120 (e.g., an application processor) and support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a portion of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of a same type as, or a different type from, the electronic device 101. According to an embodiment, all or some of operations to be executed by the electronic device 101 may be executed at one or more of external electronic devices (e.g., the external electronic devices 102 and 104, or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

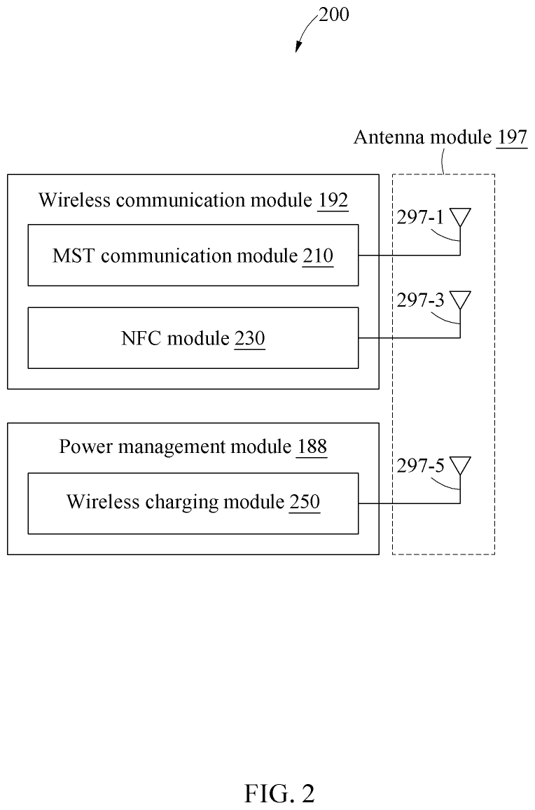

FIG. 2 is a block diagram 200 of the wireless communication module 192, the power management module 188, and the antenna module 197 of the electronic device 101 according to an embodiment.

Referring to FIG. 2, the wireless communication module 192 may include a magnetic secure transmission (MST) communication module 210 or a near-field communication (NFC) module 230, and the power management module 288 may include a wireless charging module 250. In this case, the antenna module 297 may include a plurality of antennas including an MST antenna 297-1 connected to the MST communication module 210, an NFC antenna 297-3 connected to the NFC module 230, and a wireless charging antenna 297-5 connected to the wireless charging module 250. For ease of description, the same components as those described with reference to FIG. 1 are briefly described or omitted from the description.

The MST communication module 210 may receive a signal including control information or payment information such as card information from the processor 120 (e.g., the processor 120 of FIG. 1), generate a magnetic signal corresponding to the received signal, and then transmit the generated magnetic signal to an external electronic device 102 (e.g., a POS device) (e.g., the electronic device 102 of FIG. 1) through the MST antenna 297-1. To generate the magnetic signal, according to an embodiment, the MST communication module 210 may include a switching module (not shown) including one or more switches connected to the MST antenna 297-1, and change the direction of voltage or current applied to the MST antenna 297-1 according to the received signal by controlling this switching module. As the direction of voltage or current is changed, the direction of the magnetic signal (e.g., a magnetic field) transmitted through the MST antenna 297-1 may be changed accordingly. When detected by the external electronic device 102, the magnetic signal with the changed direction may produce an effect (e.g., a waveform) similar to that of a magnetic field generated when a magnetic card corresponding to the received signal (e.g., card information) is swiped through a card reader of the electronic device 102. According to an embodiment, the payment-related information and the control signal received in the form of the magnetic signal by the electronic device 102 may be transmitted to an external server 208 (e.g., a payment server) through, for example, a network 299.

The NFC module 230 may obtain a signal including control information or payment information such as card information from the processor 120, and transmit the obtained signal to the external electronic device 102 through the NFC antenna 297-3. According to an embodiment, the NFC module 230 may receive such a signal transmitted from the external electronic device 102 via the NFC antenna 297-3.

The wireless charging module 250 may wirelessly transmit power to the external electronic device 102 (e.g., a cellular phone or a wearable device) through the wireless charging antenna 297-5, or wirelessly receive power from the external electronic device 102 (e.g., a wireless charging device). The wireless charging module 250 may support one or more of various wireless charging schemes including, for example, a magnetic resonance scheme or a magnetic induction scheme.

According to an embodiment, some of the MST antenna 297-1, the NFC antenna 297-3, or the wireless charging antenna 297-5 may share at least a portion of a radiator with each other. For example, a radiator of the MST antenna 297-1 may be used as a radiator of the NFC antenna 297-3 or the wireless charging antenna 297-5, and vice versa. In this case, the antenna module 297 may include a switching circuit (not shown) configured to selectively connect (e.g., close) or disconnect (e.g., open) at least a portion of the antennas 297-1, 297-2, or 297-3) according to the control of the wireless communication module 292 (e.g., the MST communication module 210 or the NFC module 230) or the power management module 288 (e.g., the wireless charging module 250). For example, when the electronic device 200 uses a wireless charging function, the NFC module 230 or the wireless charging module 250 may temporarily disconnect at least a partial area of the radiator shared by the NFC antenna 297-3 and the wireless charging antenna 297-5 from the NFC antenna 297-3 and connect at least the partial area of the radiator to the wireless charging antenna 297-5, by controlling the switching circuit.

According to an embodiment, at least one function of the MST communication module 210, the NFC module 230, or the wireless charging module 250 may be controlled by an external processor (e.g., the processor 120). According to an embodiment, designated functions (e.g., a payment function) of the MST communication module 210 or the NFC module 230 may be performed in a trusted execution environment (TEE). The TEE according to an embodiment may, for example, form an execution environment in which at least a partially designated area of the memory 130 (e.g., the memory 130 of FIG. 1) is assigned to be used to perform a function requiring a relatively high-level security (e.g., a function related to financial transactions or personal information). In this case, access to the designated area may be restrictively permitted, for example, according to an entity accessing the area or an application executed in the TEE.

The electronic device according to the embodiments disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st,” and “2nd,” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed herein may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

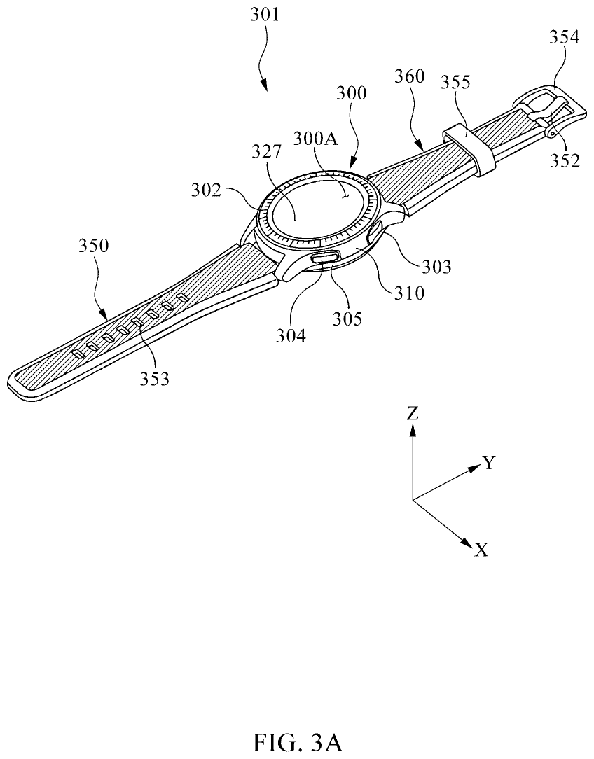

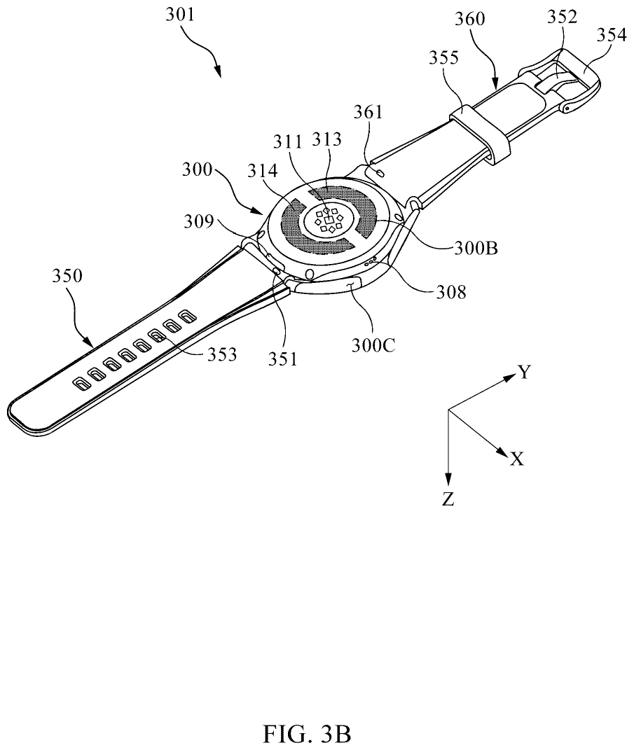

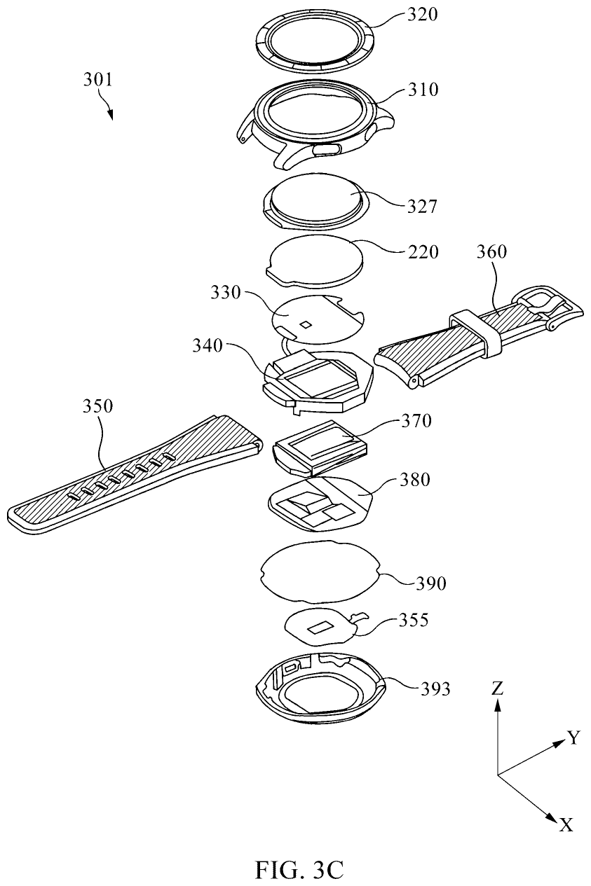

FIG. 3A is a front perspective view of a wearable electronic device according to an embodiment, FIG. 3B is a rear perspective view of the wearable electronic device according to an embodiment, and FIG. 3C is an exploded perspective view of the wearable electronic device according to an embodiment.

Referring to FIGS. 3A to 3C, an electronic device 301 (e.g., the electronic device 101 of FIG. 1) according to an embodiment may include a housing 300 including a front surface (or a first surface) 300A, a rear surface (or a second surface) 300B, and a side surface 300C surrounding a space between the front surface 300A and the rear surface 300B, and straps 350 and 360 connected to at least a portion of the housing 300 and configured to detachably attach the electronic device 301 to a body part (e.g., a wrist, an ankle, etc.) of a user. In another embodiment (not shown), the housing 300 may also refer to a structure that forms a portion of the front surface 300A, the rear surface 300B, and the side surface 300C of FIG. 3A. According to an embodiment, the front surface 300A may be formed by a front plate 320 (e.g., a glass plate or a polymer plate including various coating layers) of which at least a portion is substantially transparent. The rear surface 300B may be formed by a rear plate 393 that is substantially opaque. The rear plate 393 may be formed of, for example, coated or colored glass, a ceramic, a polymer, a metal (e.g., aluminum, stainless steel (SS), or magnesium), or a combination of at least two thereof. The side surface 300C may be coupled to the front plate 320 and the rear plate 393 and may be formed by a side frame (or a “bezel structure”) 310 including a metal and/or a polymer. In some embodiments, the rear plate 397 and the side frame 310 may be integrally formed and may include the same material (e.g., a metal material such as aluminum).

According to an embodiment, the electronic device 301 may include at least one of a display 327, audio modules 305 and 308, a sensor module 311, key input devices 302, 303, and 304, and a connector hole 309. In some embodiments, the electronic device 301 may not include at least one (e.g., the key input devices 302, 303, and 304, the connector hole 309, or the sensor module 311) of the components, or additionally include other components.

The display 327 may be exposed through, for example, some portions of the front plate 320. The display 327 may have a shape corresponding to the shape of the front plate 320, and may have various shapes such as a circle, an oval, or a polygon. The display 327 may be coupled to or disposed adjacent to a touch sensing circuit, a pressure sensor capable of measuring an intensity (or pressure) of a touch, and/or a fingerprint sensor.

The audio modules 305 and 308 may include a microphone hole 305 and a speaker hole 308. A microphone for acquiring an external sound may be disposed in the microphone hole 305. In some embodiments, a plurality of microphones may be disposed to detect a direction of a sound. The speaker hole 308 may be used as an external speaker and a call receiver for calls. In some embodiments, the speaker hole 308 and the microphone hole 305 may be implemented as a single hole, or a speaker (e.g., a piezo speaker) may be included without the speaker hole 308.

The sensor module 311 may generate an electrical signal or a data value corresponding to an internal operating state of the electronic device 301 or an external environmental state. The sensor module 311 may include, for example, a biometric sensor 311 (e.g., a heart rate monitor (HRM) sensor) disposed on the rear surface 300B of the housing 300. In an embodiment, the electronic device 301 may further include at least one of sensor modules not shown, for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The sensor module 311 may include electrode areas 313 and 314 that form a portion of the surface of the electronic device 301 and a biosignal detection circuit (not shown) electrically connected to the electrode areas 313 and 314. For example, the electrode areas 313 and 314 may include a first electrode area 313 and a second electrode area 314 disposed on the rear surface 300B of the housing 300. The sensor module 311 may be configured such that the electrode areas 313 and 314 obtain an electrical signal from a body part of the user, and the biosignal detection circuit detects biometric information of the user based on the electrical signal.

The key input devices 302, 303, and 304 may include a wheel key 302 disposed on the first surface 300A of the housing 300 and rotatable in at least one direction, and/or side key buttons 303 and 304 disposed on the side surface 300C of the housing 300. The wheel key 302 may have a shape corresponding to the shape of the front plate 320. In another embodiment, the electronic device 301 may not include some or all of the above-described key input devices 302, 303, and 304, and the key input devices 302, 303, and 304 that are not included may be implemented in other forms such as soft keys on the display 327.

The connector hole 309 may include another connector hole (not shown) that accommodates a connector (e.g., a universal serial bus (USB) connector) for transmitting and receiving power and/or data to and from an external electronic device and accommodates a connector for transmitting and receiving an audio signal to and from an external electronic device. The electronic device 301 may further include, for example, a connector cover (not shown) that covers at least a portion of the connector hole 309 and blocks infiltration of external foreign materials into the connector hole (309).

In an embodiment, the straps 350 and 360 may be formed of various materials in various shapes. For example, the straps 350 and 360 may be formed of woven fabric, leather, rubber, urethane, metal, ceramic, or a combination of at least two of the aforementioned materials and may be implemented in an integrated form or with a plurality of unit links that are movable relative to each other. In an embodiment, the straps 350 and 360 may be detachably attached to at least a partial area of the housing 300 using locking members 351 and 361. The straps 350 and 360 may include one or more of a fixing member 352, a fixing member fastening hole 353, a band guide member 354, and a band fixing ring 355.

The fixing member 352 may be configured to fix the housing 300 and the straps 350 and 360 to a body part (e.g., a wrist, an ankle, etc.) of the user. The fixing member fastening hole 353 may correspond to the fixing member 352 and fix the housing 300 and the straps 350 and 360 to the body part of the user. The band guide member 354 may be configured to limit the range of movement of the fixing member 352 when the fixing member 352 is fastened to the fixing member fastening hole 353, so that the straps 350 and 360 may be closely attached to the body part of the user. The band fixing ring 355 may limit the range of movement of the straps 350 and 360 in a state in which the fixing member 352 and the fixing member fastening hole 353 are fastened with each other.

In an embodiment, the electronic device 301 may include the side frame 310, the front plate 320, the display 327, a first antenna 330, a second antenna 350b, a support member 340 (e.g., a bracket), a battery 370, a printed circuit board (PCB) 380, a sealing member 390, a rear plate 393, and the straps 350 and 360.

The support member 340 may be disposed inside the electronic device 301 and connected to the side frame 310, or may be integrally formed with the side frame 310. The support member 360 may be formed of, for example, a metal material and/or a non-metal material (e.g., a polymer). The display 327 may be connected to one surface of the support member 360, and the PCB 380 may be connected to the other surface of the support member 360. The PCB 380 may be provided with a processor, a memory, and/or an interface mounted thereon. The processor (e.g., the processor 120 of FIG. 1) may include, for example, one or more of a CPU, an AP, a GPU, an AP sensor processor, or a CP.

The memory may include, for example, a volatile memory or a non-volatile memory. The interface may include, for example, an HDMI, a USB interface, an SD card interface, or an audio interface. For example, the interface may electrically or physically connect the electronic device 300 to an external electronic device, and may include a USB connector, an SD card/multimedia card (MMC) connector, or an audio connector.

The battery 370, which is a device for supplying power to at least one component of the electronic device 300, may include, for example, a non-rechargeable primary battery, a rechargeable secondary battery, or a fuel cell. For example, at least a portion of the battery 370 may be disposed on substantially the same plane as the PCB 380. The battery 370 may be disposed integrally inside the electronic device 300, or disposed detachably from the electronic device 300.

The first antenna 330 may be disposed between the display 327 and the support member 340. The first antenna 330 may include, for example, an NFC antenna, a wireless charging antenna, and/or an MST antenna. For example, the first antenna 330 may perform short-range communication with an external device, wirelessly transmit and receive power used for charging, or transmit a magnetism-based signal including a short-range communication signal or payment data. In another embodiment, an antenna structure may be formed by the side frame 310 and/or a portion of the support member 340, or a combination thereof.

The second antenna 350b may be disposed between the PCB 380 and the rear plate 393. The second antenna 350b may include, for example, an NFC antenna, a wireless charging antenna, and/or an MST antenna. For example, the second antenna 350b may perform short-range communication with an external device, wirelessly transmit and receive power used for charging, or transmit a magnetism-based signal including a short-range communication signal or payment data. In another embodiment, an antenna structure may be formed by a portion of the side frame 310 and/or the rear plate 393, or a combination thereof.

The sealing member 390 may be disposed between the side frame 310 and the rear plate 393. The sealing member 390 may be configured to prevent moisture and foreign materials from being introduced into a space surrounded by the side frame 310 and the rear plate 393 from the outside.

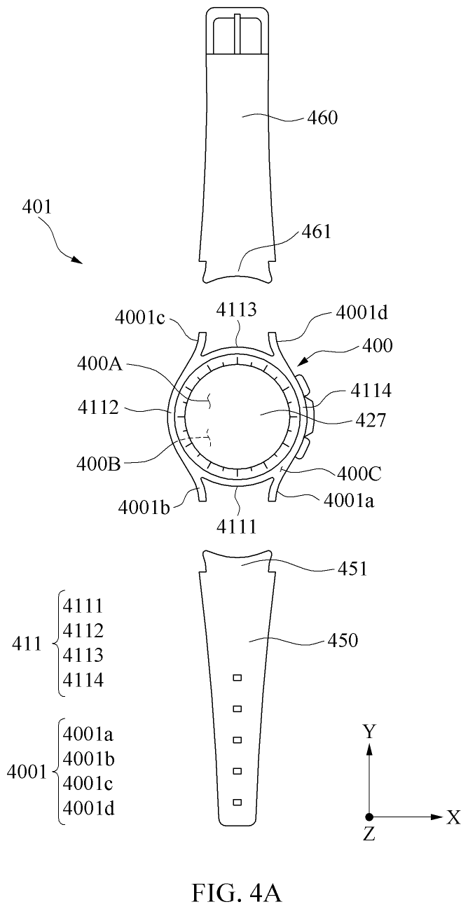

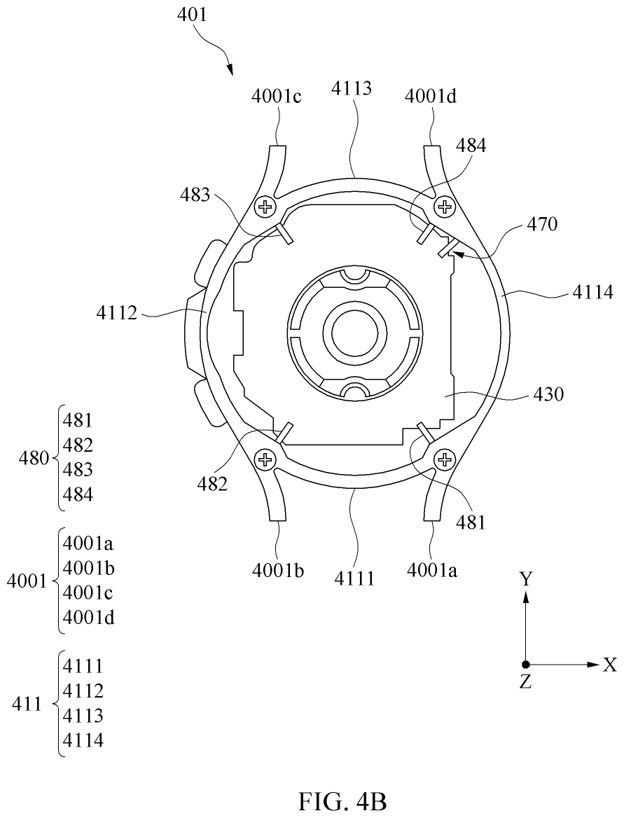

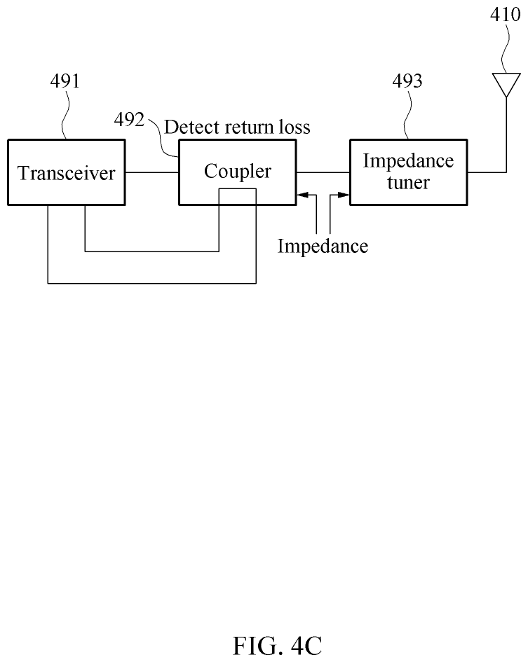

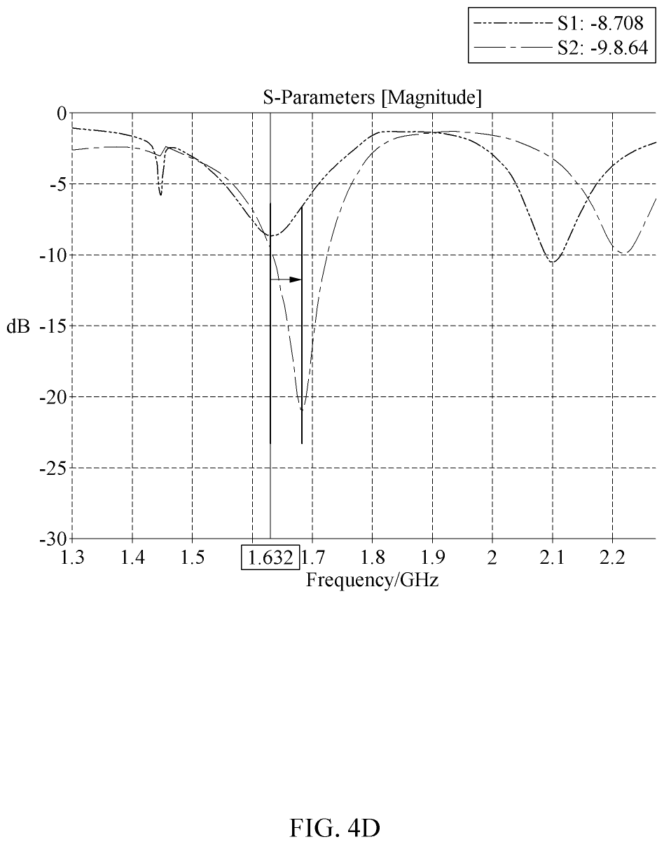

FIG. 4A is a plan view of a wearable electronic device according to an embodiment, FIG. 4B is a plan view illustrating an antenna structure of the wearable electronic device according to an embodiment, FIG. 4C is a block diagram illustrating the antenna structure of the wearable electronic device according to an embodiment, and FIG. 4D is a graph illustrating a signal loss due to metal straps mounted on the wearable electronic device according to an embodiment.

Referring to FIGS. 4A to 4D, a wearable electronic device 401 according to an embodiment may include a housing 400 (e.g., the housing 300 of FIG. 3A), straps 450 and 460 (e.g., the straps 350 and 360 of FIG. 3A) connected to the housing 400, a display 427 (e.g., the display 327 of FIG. 3A), a PCB 430 (e.g., the PCB 380 of FIG. 3A), a wireless communication circuit (e.g., the wireless communication module 192 of FIG. 1), an antenna structure, a transceiver 491, an impedance tuner 493, and a coupler 492.

In an embodiment, the housing 400 may include a front surface 400A facing a first direction (e.g., the +Z direction of FIG. 4A), a rear surface 400B facing a second direction (e.g., the −Z direction of FIG. 4A), and a side surface 400C surrounding an inner space between the front surface 400A and the rear surface 400B. The first direction that the front surface 400A faces and the second direction that the rear surface 400B faces may be opposite to each other. In an embodiment, the side surface 400C may surround the inner space formed between the front surface 400A and the rear surface 400B. Various components (e.g., the battery, the PCB, etc.) of the wearable electronic device 401 may be disposed in the inner space of the housing 400 surrounded by the side surface 400C.

In an embodiment, the housing 400 may include a side frame 410 that forms at least a portion of the side surface 400C. For example, the side frame 410 may connect the front surface 400A and the rear surface 400B along the periphery of the front surface 400A or the rear surface 400B. In another embodiment, the side frame 410 may form at least a portion of the front surface 400A or the rear surface 400B. In an embodiment, the side frame 410 may be formed in the shape of a closed loop that surrounds the perimeter of the front surface 400A, based on a state in which the front surface 400A is viewed as shown in FIG. 4A.

In an embodiment, the housing 400 may include a plurality of lugs 4001 for mounting the straps 450 and 460. In an embodiment, the plurality of lugs 4001 may be formed on the side 400C of the housing 400. For example, the plurality of lugs 4001 may be formed to protrude in outward directions from the side surface 400C, based on the state in which the front surface 400A is viewed as shown in FIG. 4A. For example, the plurality of lugs 4001 may be formed on the side frame 410. In an embodiment, the plurality of lugs 4001 may include a first lug 4001a and a second lug 4001b for connecting the first strap 450, and a third lug 4001c and a fourth lug 4001d for mounting the second strap 460. The first lug 4001a and the second lug 4001b may be connected to a fastening portion 451 of the first strap 450 to secure the first strap 450 to the housing 400, and the third lug 4001c and the fourth lug 4001d may be connected to a fastening portion 461 of the second strap 460 to secure the second strap 460 to the housing 400. In an embodiment, the plurality of lugs 4001 may be disposed on the side surface 400C of the housing 400 to be spaced apart from each other. For example, based on the state in which the front surface 400A is viewed as shown in FIG. 4A, the first lug 4001a and the second lug 4001b may protrude from the side surface 400C of the housing 400 to face the −Y-axis direction, and the third lug 4001c and the fourth lug 4001d may protrude from the side surface 400C of the housing 400 to face the +Y-axial direction. For example, the first lug 4001a, the second lug 4001b, the third lug 4001c, and the fourth lug 4001d may be disposed on the side surface 400C of the housing 400 sequentially in a clockwise direction, based on FIG. 4A.

In an embodiment, the side frame 410 may include a plurality of areas divided based on the plurality of lugs 4001. For example, the side frame 410 may include, based on the state in which the front surface 400A is viewed as shown in FIG. 4A, a first portion 4111 positioned between the first lug 4001a and the second lug 4001b, a second portion 4112 positioned between the second lug 4001b and the third lug 4001c, a third portion 4113 positioned between the third lug 4001c and the fourth lug 4001d, and a fourth portion 4114 positioned between the fourth lug 4001d and the first lug 4001a. In an embodiment, the fastening part 451 of the first strap 450 may be positioned in the first portion 4111, and the fastening part 461 of the second strap 460 may be positioned in the third portion 4113.

In an embodiment, the straps 450 and 460 may attach the wearable electronic device 401 to the body of the user. In an embodiment, the straps 450 and 460 may be formed at least partially of a conductive material (e.g., a metal) or entirely of a non-conductive material (e.g., plastic).

In an embodiment, the display 427 may display visual information (e.g., an image and/or text). In an embodiment, at least a portion of the display 427 may be exposed to the outside through the front surface 400A of the housing 400. For example, a portion of the front surface 400A of the housing 400 may be open or formed of a transparent material, and the display 427 may be disposed in the inner space of the housing 400 and exposed to the outside through the front surface 400A of the housing 400. In an embodiment, the display 427 may include a display panel (e.g., a liquid-crystal display (LCD), an organic light-emitting diode (OLED), etc.) or a touch screen panel (TSP) to receive an input of the user.

In an embodiment, the PCB 430 may be disposed in the inner space of the housing 400. In an embodiment, a processor (e.g., the processor 120 of FIG. 1) may be disposed on the PCB 430. The processor may include, for example, one or more of a CPU, an AP, an ISP, a sensor hub processor, or a CP. In an embodiment, the PCB 430 may be electrically connected to the antenna structure.

In an embodiment, the wireless communication circuit (e.g., the wireless communication module 192 of FIG. 1) may be disposed on the PCB 430. For example, the wireless communication circuit may receive a wireless signal from an external device (e.g., the electronic device 104 of FIG. 1) or transmit a wireless signal to the external device. For example, the wireless communication circuit may transmit and receive wireless signals through an electrical path formed in the side frame 410.

In an embodiment, the wearable electronic device 401 may perform communication with the external device (e.g., the electronic device 104 of FIG. 1) through the antenna structure. The antenna structure may include the side frame 410, a feeder 470, and a plurality of ground portions 480.

In an embodiment, a portion of the side frame 410 may function as a radiator of an antenna. For example, the side frame 410 may be formed at least partially of a conductive material (e.g., a metal). The conductive portion of the side frame 410 may form an electrical path through which an electrical signal can move, thereby forming a radiation pattern in a frequency band corresponding to the electrical path. In an embodiment, the electrical path formed in the side frame 410 may be changed. Depending on the electrical path formed in the side frame 410, the radiation pattern of an electromagnetic wave generated in the side frame 410 and the resonant frequency band of the electrical signals transmitted and received through the side frame 410 may be changed. In an embodiment, the wireless communication circuit may apply an electrical signal to the side frame 410 through the feeder 470. For example, a wireless communication circuit 490 may apply an electrical signal (e.g., a radio frequency (RF) signal) to the side frame 410 according to data received from the processor. The wireless communication circuit may transmit and receive an electrical signal corresponding to the electrical path formed in the side frame 410.

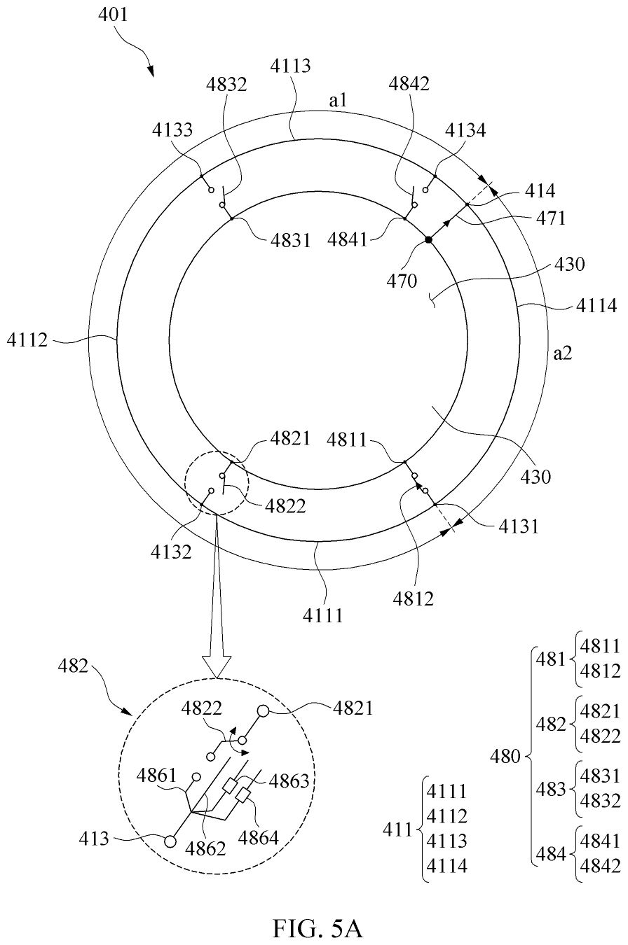

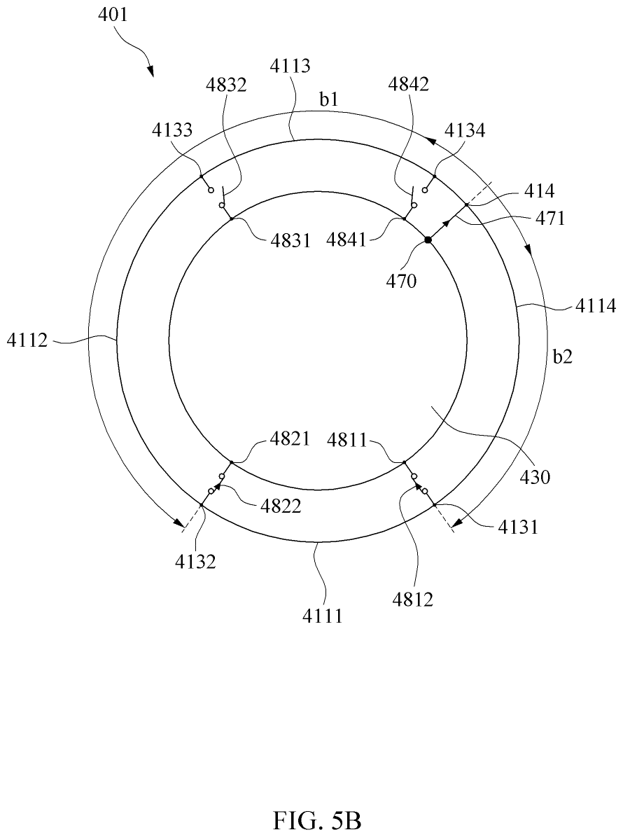

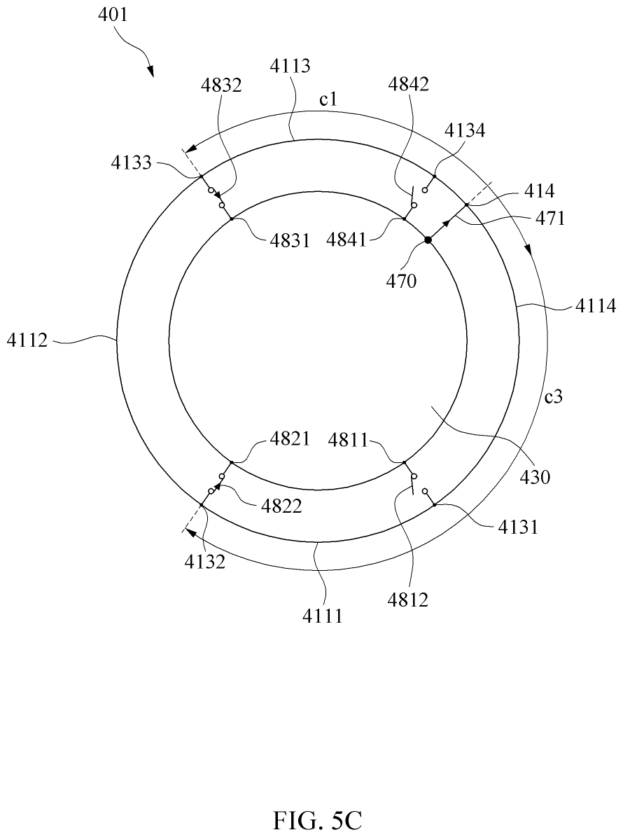

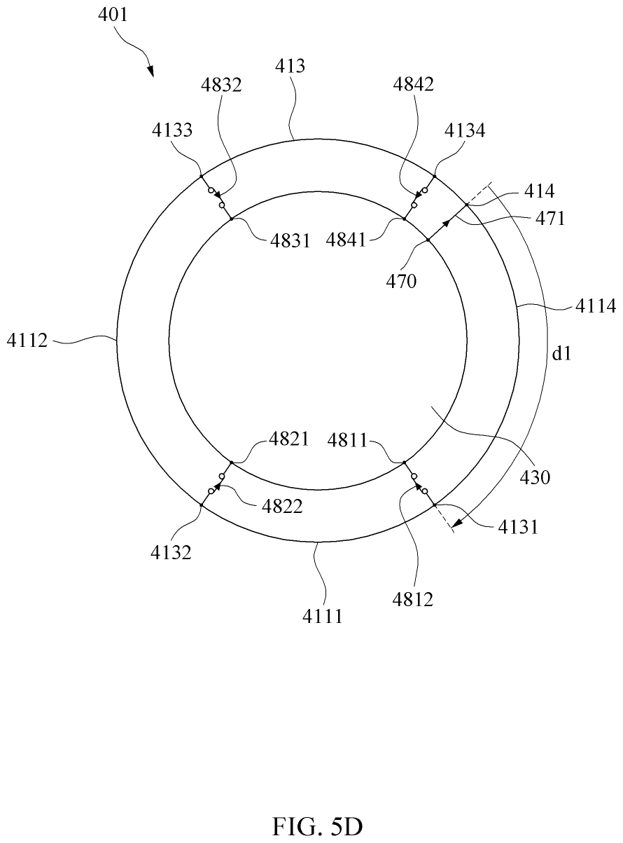

In an embodiment, the feeder 470 may be disposed on the PCB 430. However, this is merely for ease of description, and the position of the feeder 470 is not limited thereto. In an embodiment, the feeder 470 may be electrically connected to the wireless communication circuit through a feed line (e.g., a feed line 471 of FIG. 5A). In an embodiment, the feeder 470 may be electrically connected to a feed point (e.g., a feed point 414 of FIG. 5A) of the side frame 410 through a conductive elastic member (e.g., -Clip or a pogo pin). In an embodiment, the feed point where the feeder 470 is connected to the side frame 410 may be positioned in any one of the second portion 4112 or the fourth portion 4114 of the side frame 410, in a state in which the front surface is viewed as shown in FIG. 4. For example, the connection position of the feeder 470 to the side frame 410 may be between the connection point of a second ground portion 482 to the side frame 410 (e.g., a second point 4132 of FIG. 5A) and the connection point of a third ground portion 483 to the side frame 410 (e.g., a third point 4133 of FIG. 5A), or between the connection point of a first ground portion 481 to the side frame 410 (e.g., a first point 4131 of FIG. 5A) and the connection point of a fourth ground portion 484 to the side frame 410 (e.g., a fourth point 4134 of FIG. 5A). Hereinafter, for ease of description, a case where the connection point of the feeder 470 to the side frame 410 is between the connection points of the first ground portion 481 and the fourth ground portion 484 to the side frame 410 will be described as an example.

In an embodiment, the plurality of ground portions 480 may change the electrical path formed in the side frame 410. In an embodiment, each of the plurality of ground portions 480 may transmit an electrical signal applied to the side frame 410 to the ground. In an embodiment, the plurality of ground portions 480 may be respectively connected to portions of the side frame 410 adjacent to the plurality of lugs 4001. For example, the plurality of ground portions 480 may include the first ground portion 481 connected adjacent to the first lug 4001a, the second ground portion 482 connected adjacent to the second lug 4001b, the third ground portion 483 connected adjacent to the third lug 4001c, and the fourth ground portion 484 connected adjacent to the fourth lug 4001d. In an embodiment, the electrical signal flowing through the side frame 410 is selectively transmitted to the ground through each of the plurality of ground portions 480, so that the electrical path of the electrical signal applied to the side frame 410 may be set to pass through or bypass the lugs 4001.

In an embodiment, the transceiver 491 may output an electrical signal based on communication data received from the processor 420. The transceiver 491 may convert an electrical signal received from an external device into communication data recognizable by the processor 420 and transmit the communication data to the processor 420.

In an embodiment, the impedance tuner 493 may tune the electrical signal output from the transceiver 491. For example, the impedance tuner 493 may adjust the impedance of the electrical signal applied to the side frame 410 to be close to a characteristic impedance corresponding to the electrical path formed in the side frame 410. For example, the impedance tuner 493 may change the electrical length of the antenna including the side frame 410, thereby reducing a reflection loss due to a difference between the characteristic impedance corresponding to the electrical path formed in the side frame 410 and the impedance of the applied electrical signal.

In an embodiment, the coupler 492 may perform power sampling. The coupler 492 may sample a forward coupling signal from the electrical signal output from the transceiver 491 and transmit the forward coupling signal back to the transceiver 491. In an embodiment, the coupler 492 may sample a reverse coupling signal from a reflected signal according to the difference between the impedance of the electrical signal applied to the side frame 410 and the characteristic impedance and transmit the reverse coupling signal to the transceiver 491. In an embodiment, the coupler 492 may detect a voltage standing wave ratio corresponding to the sampled forward coupling signal and reverse coupling signal and transmit the detected voltage standing wave ratio to the processor 420. In an embodiment, the voltage standing wave ratio may also be transmitted from the transceiver 491 to the processor 420.

In an embodiment, the impedance of the antenna may change depending on the material of the straps 450 and 460 connected to the side frame 410. For example, when the straps 450 and 460 including a conductive material are connected to the side frame 410 through the lugs 4001, a portion of the electrical signal applied to the side frame 410 may be transmitted to the straps 450 and 460 through the lugs 4001. In this case, the impedance of the electrical signal applied to the side frame 410 may change. In another example, when the straps 450 and 460 including a non-conductive material are connected to the side frame 410 through the lugs 4001, the electrical signal applied to the side frame 410 may pass through the lugs 4001 but may not be transmitted to the straps 450 and 460. For example, a loss of the electrical signal through the straps 450 and 460 may be prevented. In this case, the electrical signal applied to the side frame 410 may have a relatively small impedance change or no substantial impedance change compared to a case where the straps 450 and 460 including a conductive material are connected to the side frame 410 through the lugs 4001.

FIG. 4D illustrates impedance changes of an antenna signal depending on the material of the straps 450 and 460 connected to the lugs 4001. S1 shown in FIG. 4D may denote the impedance detected when the straps 450 and 460 including a non-conductive material are mounted on the lugs 4001, and S2 may denote the impedance detected when the straps 450 and 460 including a conductive material are mounted on the lugs 4001. As shown in FIG. 4D, it may be seen that the impedance of an antenna structure using the side frame 410 as a radiator changes depending on the material of the straps 450 and 460. As a result, it may be confirmed that the resonant frequencies of the antennas have differences of 1.632 GHz and 1.69 GHZ, respectively, causing characteristic deteriorations in the antenna radiation performance of a required service band.

In an embodiment, the processor 420 may change a wireless communication mode of the wearable electronic device 401. In an embodiment, the processor 420 may control a short-circuit operation of the wireless communication circuit and the ground portions 480 to implement effective antenna performance. For example, the processor 420 may determine the wireless communication mode of the wearable electronic device 401 based on a change in the antenna performance depending on the material of the straps 450 and 460 connected to the housing 410.

In an embodiment, the processor 420 may change the wireless communication mode of the wearable electronic device 401 based on an impedance change detected through a wireless communication circuit (e.g., the wireless communication module 192 of FIG. 1), for example, the detected voltage standing wave ratio. For example, the processor 420 may perform an operation of switching the wireless communication mode based on a variation of the voltage standing wave ratio detected through the coupler 492. For example, the processor 420 may maintain the wireless communication mode of the wearable electronic device 401 when the variation of the detected voltage standing wave ratio detected through the coupler 492 is within a first range, and change the wireless communication mode of the wearable electronic device 401 when the variation of the voltage standing wave ratio is within a second range larger than the first range. In an embodiment, the variation of the voltage standing wave ratio may be determined depending on the material of the straps 450 and 460 connected to the housing 410. For example, when the straps 450 and 460 including a metal material are connected to the housing 400 through the lugs 4001, a phenomenon that the side frame 410 expands substantially by the metal portions of the straps 450 and 460 disposed in the first portion 4111 and the third portion 4113 of the side frame 410 may occur, causing a difference between the actual antenna performance and a target antenna performance. In an embodiment, the processor 420 may detect the material of the straps 450 and 460 mounted on the housing 400 through a change in antenna performance depending on the material of the straps 450 and 460, for example, a variation of the voltage standing wave ratio, and perform an operation of changing the wireless communication mode to achieve effective antenna performance based on the same.

In an embodiment, when it is determined to change the wireless communication mode of the wearable electronic device 401, the processor 420 may change the electrical path formed in the side frame 410 by controlling a short-circuit operation of the plurality of ground portions 480 with respect to the side frame 410 (e.g., an operation of transmitting the electrical signal to the ground). For example, when it is determined that the straps 450 and 460 including a non-conductive material are connected to the lugs, the processor 420 may control the short-circuit operation of the plurality of ground portions 480 so that the electrical signal applied to the side frame 410 may flow along an electrical path (e.g., an electrical path a1 of FIG. 5A) that passes through the first portion 4111 or the third portion 4113 of the side frame 410. In an embodiment, when it is determined that the straps 450 and 460 including a metal material are connected to the lugs 4001, the processor 420 may control the short-circuit operation of the plurality of ground portions 480 so that the electrical signal applied to the side frame 410 may be transmitted from portions adjacent to the lugs 4001 to the ground. In this case, it may be set so that the electrical signal applied to the side frame 410 may flow along an electrical path (e.g., an electrical path d2 of FIG. 5D) that does not pass through the portions of the side frame 410 to which the straps 450 and 460 are connected, for example, the first portion 4111 and the third portion 4113. For example, when the electrical path formed in the side frame 410 is set to form a path that does not pass through the first portion 4111 and the third portion 4113, a phenomenon that the electrical signal applied to the side frame 410 flows to the straps 450 and 460 of a metal material may be reduced, whereby the degradation of the antenna performance caused by the straps of the metal material may be reduced.

In an embodiment, the processor 420 may control the wireless communication circuit 490 to change the frequency band in which electrical signals are transmitted and received through the antenna structure according to a change in the wireless communication mode. In an embodiment, when the electrical path formed in the side frame 410 is changed, the wireless communication circuit may be configured to transmit and receive electrical signals in a frequency band corresponding thereto.

In an embodiment, the processor 420 may change the wireless communication mode while the wearable electronic device 401 is mounted on the body of the user. For example, the processor 420 may be configured to change the electrical path formed in the side frame 410 in a state in which the housing 400 is recognized through a biometric sensor (e.g., the biometric sensor 311 of FIG. 3C) as being mounted on the body of the user.

FIGS. 5A to 5D are diagrams illustrating paths through which an electrical signal moves in response to an operation of a switching circuit of a wearable electronic device according to an embodiment.

Referring to FIGS. 5A to 5D, the electronic device 401 according to an embodiment may include the PCB 430 on which a wireless communication circuit (e.g., the wireless communication circuit 490 of FIG. 4C) is disposed, the side frame 410 that functions as a radiator, the feeder 470, and the plurality of ground portions 480.

In an embodiment, at least a portion of the side frame 410 may form an electrical path. The side frame 410 may include the first portion 4111 positioned between the first lug 4001a and the second lug 4001b, the second portion 4112 positioned between the second lug 4001b and the third lug 4001c, the third portion 4113 positioned between the third lug 4001c and the fourth lug 4001d, and the fourth portion 4114 positioned between the fourth lug 4001d and the first lug 4001a. In an embodiment, a first strap (e.g., the first strap 450 of FIG. 4A) connected to the first lug 4001a and the second lug 4001b may be positioned in the first portion 4111, and a second strap (e.g., the second strap 460 of FIG. 4A) connected to the third lug 4001c and the fourth lug 4001d may be positioned in the third portion 4113.

In an embodiment, the feeder 470 may apply an electrical signal to the side frame 410. For example, the feeder 470 may electrically connect the PCB 430 on which a wireless communication circuit (e.g., the transceiver 491 of FIG. 4C) is disposed and the side frame 410. In an embodiment, the feeder 470 may be electrically connected to the wireless communication circuit, and may be connected to the feed point 414 of the side frame 410 through the feed line 471. According to an embodiment, the feed point 414 may be electrically connected to one of the second portion 4112 or the fourth portion 4114 of the side frame 410. For example, the feed point 414, at which the feeder 470 is connected to the side frame 410 through the feed line 471, may be positioned between the second point 4132 and the third point 4133 or between the first point 4131 and the fourth point 4134, which will be described later.

In an embodiment, the plurality of ground portions 480 may be connected to the side frame 410, and may change the electrical path through which the electrical signal applied to the side frame 410 flows. In an embodiment, the plurality of ground portions 480 may be respectively connected to different points of the side frame 410, and may transmit an electrical signal flowing through the side frame 410 to the ground according to a short-circuit operation. In an embodiment, the plurality of ground portions 480 may include the first ground portion 481 connected to the first point 4131 of the side frame 410 adjacent to the first lug 4001a, the second ground portion 482 connected to the second point 4132 of the side frame 410 adjacent to the second lug 4001b, the third ground portion 483 connected to the third point 4133 of the side frame 410 adjacent to the third lug 4001c, and the fourth ground portion 484 connected to the fourth point 4134 of the side frame 410 adjacent to the fourth lug 4001d.

In an embodiment, each of the plurality of ground portions 480 may selectively connect the side frame 410 to the ground. In an embodiment, the ground may be disposed on the PCB 430 or in another portion of the housing 400. Additionally, the plurality of ground portions 480 may each transmit an electrical signal to one ground, or may transmit an electrical signal to a plurality of separate grounds, respectively. Hereinafter, a case where the ground is disposed on the PCB 430 and each of the plurality of ground portions 480 connects the side frame 410 and the PCB 430 on which the ground is disposed will be described as an example. However, this is for ease of description, and the embodiment in which the ground portions 480 are connected to the PCB 430 is merely an example, and an embodiment in which the plurality of ground portions 480 connected to the side frame 410 are connected to a portion to which the ground is connected (e.g., another portion of the housing 400 in which the ground is formed) may also be possible.

In an embodiment, the first ground portion 481 may include a first ground point 4811 connected to the ground, and a first ground line 4812 connecting the first ground point 4811 and the first point 4131. The second ground portion 482 may include a second ground point 4821 connected to the ground, and a second ground line 4822 connecting the second ground point 4821 and the second point 4132. The third ground portion 483 may include a third ground point 4831 connected to the ground, and a third ground line 4832 connecting the third ground point 4831 and the third point 4133. The fourth ground portion 484 may include a fourth ground point 4841 connected to the ground, and a fourth ground line 4842 connecting the fourth ground point 4841 and the fourth point 4143. In an embodiment, the ground points 4811, 4821, 4831, and 4841 of the ground portions 480 may be positioned on the PCB 430.

In an embodiment, a switching circuit for performing a short-circuit operation may be formed in each of the ground lines 4812, 4822, 4832, and 4842 of the plurality of ground portions 480. In an embodiment, the electrical path through which the electrical signal applied to the side frame 410 flows may change according to the short-circuit operations of the switching circuits formed in the ground lines 4812, 4822, 4832, and 4842 of the ground portions 480. For example, the resonant frequency band of the electrical signal transmitted and received through the side frame 410 may be adjusted according to the short-circuit operations of the switching circuits respectively formed in the plurality of ground portions 480.

In an embodiment, various types of switching circuits may be formed in the ground portions 480 depending on design conditions. As an example, the enlarged view of the second ground portion 482 shown in FIG. 5A shows an example of one switching circuit applicable to each ground portion 480. For example, a switching circuit 4860 formed in the second ground line 4822 may include a plurality of ports 4861, 4862, 4863, and 4864, and a switch 4865 selectively connected to at least one of the plurality of ports 4861, 4862, 4863, and 4864. The plurality of ports 4861, 4862, 4863, and 4864 may include, for example, a first port 4861, a second port 4862, a third port 4863, and a fourth port 4864. The first port 4861 may be connected to the switch 4865 in a state in which the second ground portion 482 does not short the side frame 481 to the ground. For example, the first port 4861 may be formed as an open circuit. The second port 4862 may be connected to the switch 4865 in a state in which the ground portion 482 shorts the side frame 481 to the ground. For example, the second port 4862 may be formed as a short circuit. In an embodiment, the third port 4863 may be formed as a short circuit, and may include one or more inductors. In an embodiment, the fourth port 4864 may be formed as a short circuit, and may include one or more capacitors. When the switch 4865 is connected to any one of the second port 4862, the third port 4863, or the fourth port 4864, the second ground portion 482 may connect the side frame 481 to the ground. In this case, the frequency band of the electrical signal applied to the side frame 410 may change depending on the connection state of the switch 4865 to the second port 4862, the third port 4863, or the fourth port 4864. Meanwhile, the above-described switch circuit structure is an example for ease of description, and it should be noted that the switching circuits formed on the ground lines 4812, 4822, 4832, and 4842 of the ground portions 480 may be in different structures and the structures of the switch circuits formed in the ground lines 4812, 4822, 4832, and 4842 are not limited to the above example.

In an embodiment, the plurality of ground portions 480 may be selectively shorted to the side frame 410 through the operation of the switch 4865 formed on the ground lines 4812, 4822, 4832, and 4842, thereby changing the electrical path formed in the side frame 410. In an embodiment, the short-circuiting operations of the plurality of ground portions 481, 482, 483, and 484 may be determined according to a wireless communication mode of the wearable electronic device 401.

In an embodiment, when straps (e.g., the straps 450 and 460 of FIG. 4A) including a non-conductive material are mounted on the wearable electronic device 401 (or when the straps are not mounted thereon), the plurality of ground portions 480 may operate so that the electrical signal applied to the side frame 410 may move along an electrical path passing through a portion of the side frame on which the straps are mounted, for example, the first portion 4111 or the third portion 4113.

In an embodiment, the plurality of ground portions 480 may short the first ground portion 481 to the side frame 410. In this case, an electrical path leading from the feed point 414 to the first point 4131 may be formed in the side frame 410. For example, in the side frame 410, an electrical path a1 leading from the feed point 414 via the third portion 4113, the second portion 4112, and the first portion 4111 to the ground through the first point 4131 and the first ground point 4811 may be formed, or an electrical path a2 leading from the feed point 414 via the fourth portion 4114 to the ground through the first point 4131 and the first ground point 4811 may be formed. In an embodiment, the wireless communication circuit may transmit and receive a signal in a frequency band corresponding to the electrical path a1, or transmit and receive a signal in a frequency band corresponding to the electrical path a2.

In an embodiment, the plurality of ground portions 480 may operate so that the first ground portion 481 and the second ground portion 482 may be shorted to the side frame 410 (e.g., the first ground line 4812 and the second ground line 4822 may be connected to the side frame 410), as shown in FIG. 5B. In this case, in the side frame 410, an electrical path b1 leading from the feed point 414 via the third portion 4113 and the second portion 4112 to the ground through the second point 4132 and the second ground point 4821 may be formed, or an electrical path b2 leading from the feed point 414 via the fourth portion 4114 to the ground through the first point 4131 and the first ground point 4811 may be formed. In an embodiment, the wireless communication circuit may transmit and receive a signal in a frequency band corresponding to the electrical path b1, or transmit and receive a signal in a frequency band corresponding to the electrical path b2.

In an embodiment, the plurality of ground portions 480 may operate so that the second ground portion 482 and the third ground portion 483 may be shorted to the side frame 410 (e.g., the second ground line 4822 and the third ground line 4832 may be connected to the side frame 410), as shown in FIG. 5C. In this case, in the side frame 410, an electrical path c1 leading from the feed point 414 via the third portion 4113 to the ground through the third point 4133 and the third ground point 4831 may be formed, or an electrical path c2 leading from the feed point 414 via the fourth portion 4114 and the first portion 4111 to the ground through the second point 4132 and the second ground point 4821 may be formed. In an embodiment, the wireless communication circuit may transmit and receive a signal in a frequency band corresponding to the electrical path c1, or transmit and receive a signal in a frequency band corresponding to the electrical path c2.

In an embodiment, when straps including a metal material are mounted on the wearable electronic device 401, the plurality of ground portions 480 may operate so that the electrical signal applied to the side frame 410 may move along an electrical path bypassing a portion of the side frame 410 on which the straps are mounted, for example, the first portion 4111 or the third portion 4113. For example, the plurality of ground portions 480 may operate to block the electrical signal applied to the side frame 410 from flowing to the straps 450 and 460 through the first portion 4111 and the third portion 4113.

In an embodiment, the plurality of ground portions 480 may operate so that the first ground portion 481, the second ground portion 482, the third ground portion 483, and the fourth ground portion 484 may be shorted to the side frame 410, as shown in FIG. 5D. In this case, in the side frame 410, an electrical path b1 formed only in the fourth portion 4114, for example, an electrical path d1 leading from the feed point 414 via the fourth portion 4114 to the ground through the first point 4131 and the first ground point 4811 may be formed. For example, the electrical signal applied to the side frame 410 may flow through an electrical path d1 set to bypass the first portion 4111 and the third portion 4113 to which the straps are connected.

In an embodiment, the wireless communication circuit may transmit and receive a signal in a frequency band corresponding to the electrical path d1. For example, the wearable electronic device 401 may block the electrical signal applied to the side frame 410 from flowing to the straps through the lugs through a short-circuit operation of the ground portions 480, thereby effectively reducing the loss of the electrical signal and degradation of the antenna performance.

In an embodiment, the wearable electronic device 401 may selectively change the electrical path formed in the side frame 410 through the plurality of ground portions 480 based on the material of the straps, thereby securing stable wireless communication performance.

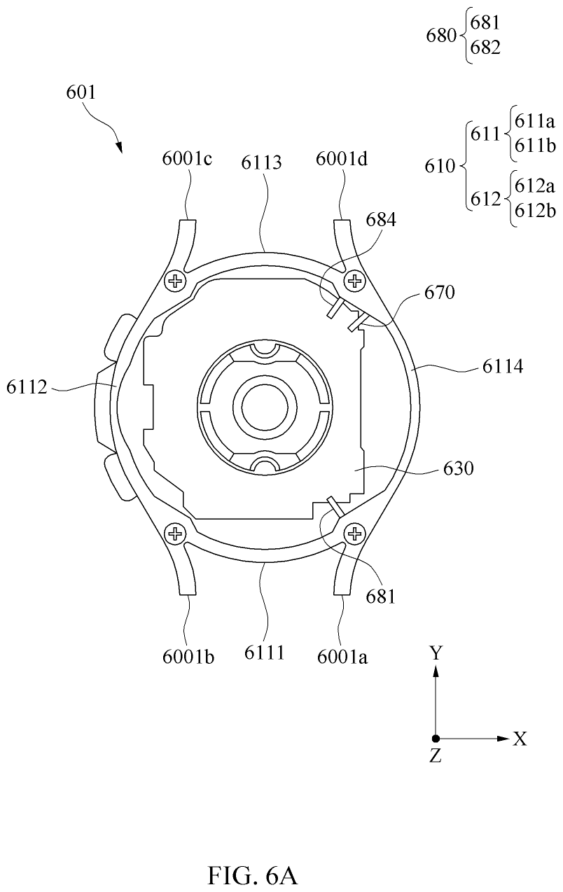

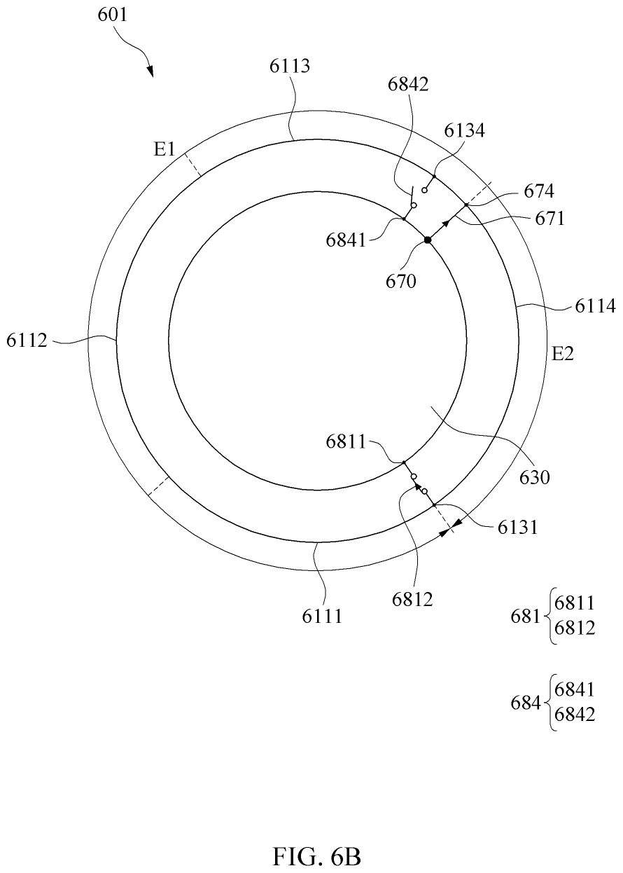

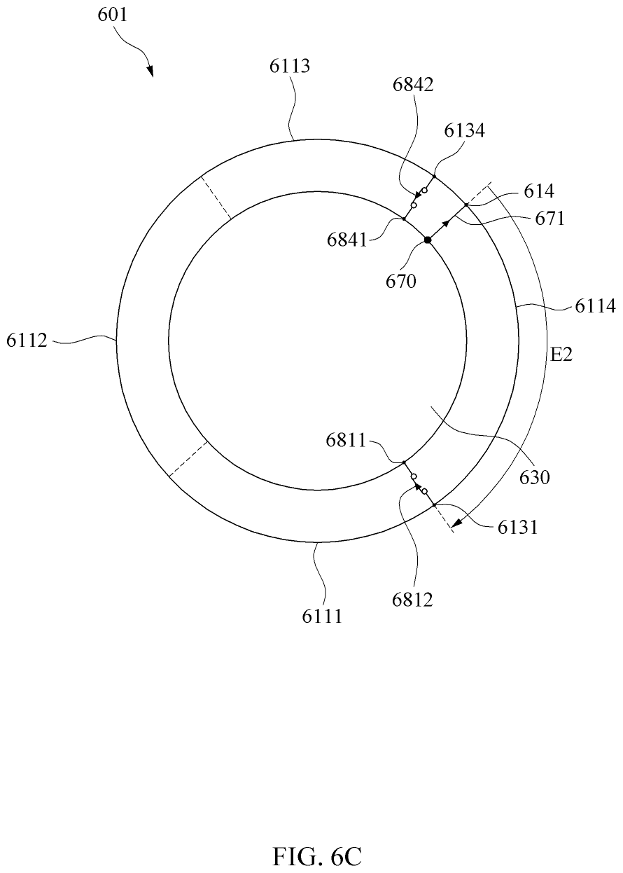

FIG. 6A is a plan view illustrating an antenna structure of a wearable electronic device according to an embodiment, and FIGS. 6B and 6C are diagrams respectively illustrating paths through which an electrical signal moves in response to an operation of a switching circuit of the wearable electronic device according to an embodiment.

Referring to FIGS. 6A to 6C, a wearable electronic device 601 according to an embodiment may include a PCB 630 (e.g., the PCB 430 of FIG. 4A) on which a wireless communication (e.g., the wireless communication circuit 490 of FIG. 4C) is disposed, a side frame 610 (e.g., the side frame 410 of FIG. 4A) that functions as a radiator, a feeder 670 (e.g., the feeder 470 of FIG. 4A), and a plurality of ground portions 680.

In an embodiment, at least a portion of the side frame 610 may form an electrical path through which an electrical signal flows. In an embodiment, the side frame 610 may include a first lug 6001a and a second lug 6001b for mounting a first strap (e.g., the first strap 450 of FIG. 4A), and a third lug 6001c and a fourth lug 6001d for mounting a second strap (e.g., the second strap 460 of FIG. 4A). In an embodiment, the side frame 610 may include, in a state in which a front surface is viewed as shown in FIG. 6A, a first portion 6111 positioned between the first lug 6001a and the second lug 6001b, a second portion 6112 positioned between the second lug 6001b and the third lug 6001c, a third portion 6113 positioned between the third lug 6001c and the fourth lug 6001d, and a fourth portion 6114 positioned between the fourth lug 6001d and the first lug 6001a. The side frame 610 may surround the PCB 630 in a closed loop form through the first portion 6111, the second part 6112, the third portion 6113, and the fourth part 6114.

In an embodiment, the feeder 670 may apply an electrical signal to the side frame 610. The feeder 670 may be electrically connected to a feed point 674 of the side frame 610 through a feed line 671.

In an embodiment, the plurality of ground portions 680 may be selectively shorted to the side frame 610 to change an electrical path formed in the side frame 610. For example, the plurality of ground portions 680 may include a first ground portion 681 selectively connected to a first point 6131 (e.g., the first point 481 of FIG. 5A) of the side frame 610 adjacent to the first lug 6001a, and a second ground portion 682 (e.g., the fourth ground portion 682 of FIG. 4A) selectively connected to a fourth point 6134 (e.g., the fourth point 484 of FIG. 5A) of the side frame 610 adjacent to the fourth lug 6001d. The first ground portion 681 may include a first ground point 6811 connected to the ground and a first ground line 6812 connecting the first ground point 6811 to the first point 6131, and the second ground portion 682 may include a second ground point 6821 connected to the ground and a second ground line 6822 connecting the second ground point 6821 to the second point 6134. A switching circuit to be selectively shorted to the side frame 610 may be formed in the first ground line 6821 and the second ground line 6822. In an embodiment, a feed point 614 may be positioned between the first point 6131 and the second point 6134.

In an embodiment, the first ground portion 681 and the second ground portion 682 may change the electrical path formed in the side frame 610 by selectively shorting the side frame 610 to the ground. The electrical path formed in the side frame 610 may be determined according to a wireless communication mode of the wearable electronic device 601.

In an embodiment, when straps including a non-conductive material are mounted on the wearable electronic device 601, the plurality of ground portions 680 may be configured so that an electrical signal applied to the side frame 610 to move along the electrical path that passes through the first portion 6111 or the third portion 6113 to which the straps are connected, as shown in FIG. 6B. For example, when the first ground portion 681 is shorted to the first point 6131 of the side frame 610 as shown in FIG. 6B, in the side frame 610, an electrical path E1 leading from the feed point 614 via the third portion 6113, the second portion 6112, and the first portion 6111 to the ground through the first point 6131 and the first ground point 6811 may be formed, or an electrical path E2 leading from the feed point 614 via the fourth portion 6114 to the ground through the first point 6131 and the first ground point 6811 may be formed. In an embodiment, the wireless communication circuit may transmit and receive a signal in a frequency band corresponding to the electrical path formed in the side frame 610.

In an embodiment, when straps including a metal material are mounted on the wearable electronic device 601, the plurality of ground portions 680 may be configured to block the electrical signal applied to the side frame 610 from flowing to the straps, as shown in FIG. 6C. For example, the first ground portion 681 and the second ground portion 682 may be shorted to the side frame 610. In this case, the electrical path E2 leading from the feed point 674 via the fourth portion 6114 to the ground through the first point 6131 and the first ground point 6811 may be formed in the side frame 610. For example, through the short-circuit operation of the first ground portion 681 and the second ground portion 682, the electrical signal applied to the side frame 610 may move to the ground so as not to pass through the first portion 6111 and the third portion 6113, and thus, a loss of the electrical signal flowing to the first portion 6111 and the third portion 6113 on which the straps are mounted may be reduced.

Hereinafter, an example of an operation of a wearable electronic device according to an embodiment will be described. In describing the operation of the wearable electronic device, it can be understood that the description is the same as the description provided above, unless stated otherwise.

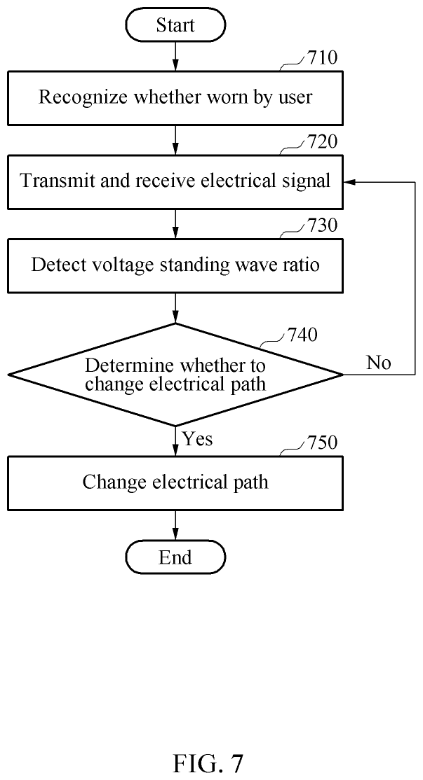

FIG. 7 is a flowchart illustrating an operating method of a wearable electronic device according to an embodiment.

In the following embodiment, operations may be performed sequentially, but are not necessarily performed sequentially. For example, the operations shown in FIG. 7 may be performed in different orders, and at least two of the operations may be performed in parallel. In addition, the operations shown in FIG. 7 are not necessarily performed, and an embodiment may be performed, excluding at least one of the operations.

In an embodiment, the operations shown in FIG. 7 may be performed by at least one component (e.g., the processor 420 of FIG. 4C) of the wearable electronic device 401.

In operation 710, the processor 420 may recognize whether the wearable electronic device 401 is worn on the body of a user. For example, the processor may recognize whether the wearable electronic device 401 is worn on the body of the user based on information detected through the biometric sensor 311.

In operation 720, the processor 420 may transmit and receive an electrical signal to and from an external device (e.g., the electronic device 104 of FIG. 1). In an embodiment, the processor 420 may transmit and receive a signal in a frequency band corresponding to an electrical path formed in the side frame 410 by applying the electrical signal to the side frame 410. For example, the processor may control a wireless communication circuit to transmit and receive an electrical signal in a frequency band corresponding to a first electrical path (e.g., the electrical path a1 of FIG. 5A) that passes through portions of the side frame 410 to which the straps 450 and 460 are connected, or to transmit and receive an electrical signal in a frequency band corresponding to a second electrical path (e.g., the electrical path d2 of FIG. 5D) that bypasses the portions (e.g., the first portion 4111 or the third portion 4133) of the side frame 410 to which the straps 450 and 460 are connected. The frequency band of a wireless signal transmitted and received by the wireless communication circuit may change depending on the electrical path formed in the side frame 610. In an embodiment, a wireless communication mode of the wearable electronic device 401 may be performed in the same manner as the mode performed before operation 720. The electrical path formed in the side frame 410 may be arbitrarily changed depending on the operation of the processor.

In operation 730, the processor 420 may detect a voltage standing wave ratio of the electrical signal applied to the side frame 410 based on a time unit of a set period and compare the detected voltage standing wave ratio with a set reference voltage standing wave ratio. For example, the processor 420 may periodically detect the voltage standing wave ratio of the electrical signal applied to the side frame 410 through the impedance tuner 493 and the coupler 492. The processor 420 may detect a variation of the voltage standing wave ratio by comparing the reference voltage standing wave ratio and the detected voltage standing wave ratio. In an embodiment, the voltage standing wave ratio of the electrical signal applied to the side frame 410 may vary depending on the material of the straps 450 and 460 connected to the lugs 4001 on the side frame. For example, when the straps 450 and 460 including a metal material are mounted on the lugs 4001, a conductive portion of the side frame may substantially expand due to the metal portions of the straps 450 and 460, causing a loss of the electrical signal or a deterioration of the antenna performance, leading to a change in the voltage standing wave ratio. On the other hand, when the straps 450 and 460 formed of a non-conductive material are mounted on the lugs 4001, the voltage standing wave ratio of the electrical signal may be maintained within a predetermined range. For example, the processor 420 may detect whether the antenna performance is degraded based on the variation of the voltage standing wave ratio.

In operation 740, the processor 420 may determine to change the wireless communication mode of the wearable electronic device 401. For example, the processor 420 may determine whether to change the electrical path formed in the side frame 410 based on the variation of the voltage standing wave ratio determined in operation 730. For example, when the variation of the detected voltage standing wave ratio relative to the reference voltage standing wave ratio is within a first range, the processor 420 may maintain the existing wireless communication mode, for example, the electrical path formed in the side frame 410 and the frequency band of the wireless signal transmitted and received through the wireless communication circuit. On the other hand, when the variation of the detected voltage standing wave ratio relative to the reference voltage standing wave ratio is within a second range different from the first range, the processor 420 may change the wireless communication mode, for example, the electrical path formed in the side frame 410 and the frequency band of the wireless signal transmitted and received through the wireless communication circuit. In an embodiment, when the processor 420 determines to maintain the existing wireless communication mode, operation 720 may be performed again. Meanwhile, rather than changing the wireless communication mode depending on the variation of the voltage standing wave ratio according to the material of the straps, the processor 420 may arbitrarily change the electrical path formed in the side frame 410 and the frequency band of the signal transmitted and received by the wireless communication circuit, according to set conditions (e.g., user settings or antenna operation state).

In operation 750, as the processor 420 switches the mode, the electrical path formed in the side frame 410 may be changed. For example, the processor 420 may control a short-circuit operation of the ground portions 481, 482, 483, and 484 so that the electrical signal applied to the side frame 410 may flow through the first electrical path passing through the portions of the side frame 410 on which the straps 450 and 460 are mounted or may flow through the second electrical path bypassing the portions of the side frame 410 on which the straps 450 and 460 are mounted. In an embodiment, when the second electrical path is formed in the side frame 410, the ground portions 480 adjacent to the lugs 4001 may be shorted to the side frame 410. In operation 750, the wireless communication circuit 490 may transmit and receive a signal to and from an external device by applying an electrical signal in a frequency band corresponding to the changed electrical path to the side frame.

A wearable electronic device 401 according to an embodiment may include a housing 400 including a front surface 400A, a rear surface 400B facing a direction opposite the front surface 400A, and a side surface 400C surrounding an inner space between the front surface 400A and the rear surface 400B, a PCB 430 disposed in the inner space and including a ground, a wireless communication circuit disposed on the PCB 430, an antenna structure electrically connected to the wireless communication circuit and configured to transmit and receive a wireless signal, and a processor 420, wherein the housing 400 may include a first lug 4001a and a second lug 4001b formed on the side surface 400C so that a first strap 450 may be mounted thereon, and a third lug 4001c and a fourth lug 4001d formed on the side surface 400C so that a second strap 460 may be mounted thereon, the antenna structure may include a side frame 410 of a conductive material surrounding the PCB 430 and forming at least a portion of the side surface 400C, a feeder 470 configured to apply an electrical signal to the side frame 410, and a plurality of ground portions 480 configured to selectively connect the side frame 410 to the ground, and the plurality of ground portions 480 may include a first ground portion 481 selectively connected to a first point 4131 of the side frame 410 adjacent to the first lug 4001a, a second ground portion 482 selectively connected to a second point 4132 of the side frame 410 adjacent to the second lug 4001b, a third ground portion 483 selectively connected to a third point 4133 of the side frame 410 adjacent to the third lug 4001c, and a fourth ground portion 484 selectively connected to a fourth point 4143 of the side frame adjacent to the fourth lug 4001d.

In an embodiment, the plurality of ground portions 480 may be configured to change an electrical path through which the electrical signal applied to the side frame 410 flows, based on a material of the first strap 450 or the second strap 460.

In an embodiment, the processor 420 may be configured to, when it is determined that the first strap 450 or the second strap 460 mounted on the housing 400 includes a metal material, control a short circuit of the plurality of ground portions 480 with respect to the side frame 410 to prevent the electrical signal applied to the side frame 410 from flowing to the first strap 450 or the second strap 460.

In an embodiment, the processor 420 may be configured to, when it is determined that the first strap 450 or the second strap 460 includes a metal material, control the first ground portion 481, the second ground portion 482, the third ground portion 483, and the fourth ground portion 484 to be shorted to the side frame 410.

In an embodiment, based on a state in which the front surface 400A is viewed, the side frame 410 may include a first portion 4111 positioned between the first lug 4001a and the second lug 4001b, a second portion 4112 positioned between the second lug 4001b and the third lug 4001c, a third portion 4113 positioned between the third lug 4001c and the fourth lug 4001d, and a fourth portion 4114 positioned between the fourth lug 4001d and the first lug 4001a, and the plurality of ground portions 480 may be configured to change an electrical path formed in the side frame 410 based on a change in impedance of the electrical signal applied to the side frame 410.

In an embodiment, in a state in which the first ground portion 481, the second ground portion 482, the third ground portion 483, and the fourth ground portion 484 are connected to the side frame 410, an electrical path d2 that bypasses the first portion 4111 and the third portion 4113 may be formed in the side frame 410.

In an embodiment, in a state in which the first ground portion 481, the second ground portion 482, the third ground portion 483, and the fourth ground portion 484 are not connected to the side frame 410, an electrical path that passes through the first portion 4111 and the third portion 4113 may be formed in the side frame 410.

In an embodiment, the wearable electronic device 401 may further include an impedance tuner 493 configured to tune the electrical signal applied to the side frame 410, and a coupler 492 configured to detect a voltage standing wave ratio, wherein the electrical path may be determined based on the voltage standing wave ratio detected through the coupler 492.

In an embodiment, the plurality of ground portions 480 may operate to form an electrical path that passes through the first portion 4111 or the third portion 4113 in the side frame 410, when a value of the detected voltage standing wave ratio is within a first range, and may operate to form an electrical path that bypasses the first portion 4111 and the third portion 4113 in the side frame 410, when the value of the detected voltage standing wave ratio is within a second range.

In an embodiment, the feeder 470 may be connected to a feed point 474 of the side frame 410, and the feed point 474 may be, based on a state in which the front surface 400A is viewed, positioned between the second point 4132 and the third point 4133 or between the first point 4131 and the fourth point 4134.

In an embodiment, the wearable electronic device 401 may further include a biometric sensor 311 configured to detect whether the housing 400 is mounted on a body of a user.

In an embodiment, the plurality of ground portions 480 may be configured to change an electrical path formed in the side frame 410, in a state in which it is recognized through the biometric sensor 311 that the housing 400 is mounted on the body of the user.

An operating method of a wearable electronic device 401 according to an embodiment may include transmitting and receiving an electrical signal in a corresponding frequency band through an electrical path formed in a side frame 410 to which a strap 450 or 460 is connected, detecting a voltage standing wave ratio of the electrical signal based on a set time unit, determining whether to change the electrical path formed in the side frame 410 based on the detected voltage standing wave ratio, changing the electrical path formed in the side frame 410, and transmitting and receiving an electrical signal in a frequency band corresponding to the changed electrical path.

In an embodiment, the changing of the electrical path formed in the side frame 410 may include changing the electrical path formed in the side frame to any one of a first electrical path that passes through a side frame portion to which the strap is connected, and a second electrical path that bypasses the side frame portion to which the strap is connected.

In an embodiment, the determining of whether to change the electrical path may include maintaining the electrical path when a variation of the detected voltage standing wave ratio is within a first range, and changing the electrical path when the variation of the detected voltage standing wave ratio is within a second range larger than the first range.

In an embodiment, the operating method of the wearable electronic device 401 may further include recognizing whether the wearable electronic device 401 is worn on a user, and the determining of whether to change the electrical path may be performed when it is recognized that the wearable electronic device 401 is worn on the user.

A wearable electronic device according to an embodiment may include a housing 400 including a front surface 400A facing a first direction, a rear surface 400B facing a second direction opposite the first direction, and a side surface 400C surrounding an inner space between the front surface 400A and the rear surface 400B, a PCB 430 disposed in the inner space, a wireless communication circuit disposed on the PCB 430, a processor 420, and an antenna structure configured to transmit and receive a wireless signal, wherein the housing 400 may include a first lug 4001a and a second lug 4001b connected to the side surface 400C so that a first strap 450 may be mounted thereon, and a third lug 4001c and a fourth lug 4001d connected to the side surface 400C so that a second strap 460 may be mounted thereon, the antenna structure may include a side frame 410 of a conductive material surrounding the PCB 430, forming at least a portion of the side surface 400C, and including a first portion 4111 positioned between the first lug 4001a and the second lug 4001b, a second portion 4112 positioned between the second lug 4001b and the third lug 4001c, a third portion 4113 positioned between the third lug 4001c and the fourth lug 4001d, and a fourth portion 4114 positioned between the fourth lug 4001d and the first lug 4001a, a feeder 470 connected to a feed point 474 of the side frame 410 and configured to apply an electrical signal to the side frame, and a plurality of ground portions 480 configured to selectively connect different points of the side frame 410 to a ground so that an electrical path formed in the side frame 410 may change, and the wireless communication circuit may be configured to transmit and receive a signal in a first frequency band when a first electrical path that passes through the first portion 4111 or the third portion 4113 is formed in the side frame 410, and transmit and receive a signal in a second frequency band when a second electrical path that bypasses the first portion 4111 and the third portion 4113 is formed in the side frame 410.

In an embodiment, the plurality of ground portions 480 may include a first ground portion 481 selectively connected to a first point 4131 of the side frame 410 adjacent to the first lug 4001a, a second ground portion 482 selectively connected to a second point 4132 of the side frame adjacent to the second lug 4001b, a third ground portion 483 selectively connected to a third point 4133 of the side frame 410 adjacent to the third lug 4001c, and a fourth ground portion 484 selectively connected to a fourth point 4134 of the side frame 410 adjacent to the fourth lug 4001d.

In an embodiment, based on a state in which the front surface 400A is viewed, the feed point 474 may be positioned between the second point 4132 and the third point 4133, or between the first point 4131 and the fourth point 4134.

In an embodiment, the antenna structure may further include an impedance tuner 493 configured to tune the electrical signal applied to the side frame, and a coupler 492 configured to detect a voltage standing wave ratio of the electrical signal, and the processor 420 may operate the plurality of ground portions 480 so that the second electrical path may be formed in the side frame 410, when it is determined that the first strap 450 or the second strap 460 connected to the housing 400 includes a metal material based on the voltage standing wave ratio detected through the coupler 492.

1. A wearable electronic device (301; 401) comprising:
a housing (400) comprising a front surface (400A), a rear surface (400B) facing a direction opposite the front surface (400A), and a side surface (400C) surrounding an inner space between the front surface (400A) and the rear surface (400B);
a printed circuit board (PCB) (430) disposed in the inner space and comprising a ground;
a wireless communication circuit disposed on the PCB (430);
an antenna structure electrically connected to the wireless communication circuit and configured to transmit and receive a wireless signal; and
a processor (420),
wherein the housing (400) comprises a first lug (4001a) and a second lug (4001b) formed on the side surface (400C) so that a first strap (450) is mounted thereon, and a third lug (4001c) and a fourth lug (4001d) formed on the side surface (400C) so that a second strap (460) is mounted thereon,
wherein the antenna structure comprises:
a side frame (410) forming at least a portion of the side surface and comprising a conductive material;
a feeder (470) configured to apply an electrical signal to the side frame (410); and
a plurality of ground portions (480) configured to selectively connect the side frame (410) to the ground, and
wherein the plurality of ground portions (480) comprise:
a first ground portion (481) selectively connected to a first point (4131) of the side frame (410) adjacent to the first lug (4001a);
a second ground portion (482) selectively connected to a second point (4132) of the side frame (410) adjacent to the second lug (4001b);
a third ground portion (483) selectively connected to a third point (4133) of the side frame (410) adjacent to the third lug (4001c); and
a fourth ground portion (484) selectively connected to a fourth point (4134) of the side frame (410) adjacent to the fourth lug (4001d).

2. The wearable electronic device of claim 1, wherein
the plurality of ground portions (480) are configured to
change an electrical path through which the electrical signal applied to the side frame (410) flows, based on a material of the first strap (450) or the second strap (460). in

3. The wearable electronic device of any one of claims 1 and 2, wherein
the processor (420) is configured to,
when it is determined that the first strap (450) or the second strap (460) mounted on the housing (400) comprises a metal material,
control a short circuit of the plurality of ground portions (480) with respect to the side frame (410) to prevent the electrical signal applied to the side frame from flowing to the first strap (450) or the second strap (460).

4. The wearable electronic device of any one of claims 1 to 3, wherein
the processor (420) is configured to,
when it is determined that the first strap (450) or the second strap (460) comprises a metal material,
control the first ground portion (481), the second ground portion (482), the third ground portion (483), and the fourth ground portion (484) to be shorted to the side frame (410).

5. The wearable electronic device of any one of claims 1 to 4, wherein
based on a state in which the front surface (400A) is viewed,
the side frame (410) comprises:
a first portion (4111) positioned between the first lug (4001a) and the second lug (4001b);
a second portion (4112) positioned between the second lug (4001b) and the third lug (4001c);
a third portion (4113) positioned between the third lug (4001c) and the fourth lug (4001d); and
a fourth portion (4114) positioned between the fourth lug (4001d) and the first lug (4001a), and
the plurality of ground portions (480) are configured to
change an electrical path formed in the side frame (410) based on a change in impedance of the electrical signal applied to the side frame (410).

6. The wearable electronic device of one of claims 1 to 5, wherein
in a state in which the first ground portion (481), the second ground portion (482), the third ground portion (483), and the fourth ground portion (484) are connected to the side frame (410), an electrical path (d2) that bypasses the first portion (4111) and the third portion (4113) is formed in the side frame (410).

7. The wearable electronic device of any one of claims 1 to 6, wherein
in a state in which the first ground portion (481), the second ground portion (482), the third ground portion (483), and the fourth ground portion (484) are not connected to the side frame (410), an electrical path that passes through the first portion (4111) and the third portion (4113) is formed in the side frame (410).

8. The wearable electronic device of any one of claims 1 to 7, further comprising:
an impedance tuner (493) configured to tune the electrical signal applied to the side frame (410); and
a coupler (492) configured to detect a voltage standing wave ratio, wherein the electrical path is determined based on the voltage standing wave ratio detected through the coupler (492).

9. The wearable electronic device of any one of claims 1 to 8, wherein
the plurality of ground portions (480)
operate to form an electrical path that passes through the first portion (4111) or the third portion (4113) in the side frame (410), when a value of the detected voltage standing wave ratio is within a first range, and
operate to form an electrical path that bypasses the first portion (4111) and the third portion (4113) in the side frame (410), when the value of the detected voltage standing wave ratio is within a second range.

10. The wearable electronic device of any one of claims 1 to 9, wherein
the feeder (470) is connected to a feed point (474) of the side frame (410), and
the feed point (474) is,
based on a state in which the front surface (400A) is viewed,
positioned between the second point (4132) and the third point (4133) or between the first point (4131) and the fourth point (4134).

11. The wearable electronic device of any one of claims 1 to 10, further comprising:
a biometric sensor (311) configured to detect whether the housing (400) is mounted on a body of a user.

12. The wearable electronic device of any one of claims 1 to 11, wherein
the plurality of ground portions (480) are configured to:
change an electrical path formed in the side frame (410), in a state in which it is recognized through the biometric sensor (311) that the housing (400) is mounted on the body of the user.

13. An operating method of a wearable electronic device (401), the operating method comprising:
transmitting and receiving an electrical signal in a corresponding frequency band through an electrical path formed in a side frame (410) to which a strap (450, 460) is connected;
detecting a voltage standing wave ratio of the electrical signal based on a set time unit;
determining whether to change the electrical path formed in the side frame (410) based on the detected voltage standing wave ratio;
changing the electrical path formed in the side frame (410); and
transmitting and receiving an electrical signal in a frequency band corresponding to the changed electrical path.

14. The operating method of claim 13, wherein
the changing of the electrical path formed in the side frame (410) comprises
changing the electrical path formed in the side frame to any one of:
a first electrical path that passes through a side frame portion to which the strap is connected; and
a second electrical path that bypasses the side frame portion to which the strap is connected.

15. The operating method of any one of claims 13 and 14, wherein
the determining of whether to change the electrical path comprises:
maintaining the electrical path when a variation of the detected voltage standing wave ratio is within a first range; and
changing the electrical path when the variation of the detected voltage standing wave ratio is within a second range larger than the first range.
